(19) United States
(12) Patent Application Publication
(10) Pub. No.: US 2010/0310269 A1
(43) Pub. Date: Dec. 9, 2010

(54) IMAGE FORMING APPARATUS

(75) Inventor: Yoshihisa MASUDA, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/793,214

(22) Filed: Jun. 3, 2010

Related U.S. Application Data
(60) Provisional application No. 61/183,641, filed on Jun. 3, 2009.
(60) Provisional application No. 61/183,655, filed on Jun. 3, 2009.
(60) Provisional application No. 61/183,656, filed on Jun. 3, 2009.
(60) Provisional application No. 61/187,177, filed on Jun. 15, 2009.

(51) Int. Cl. G03G 21/00

(52) U.S. Cl. 399/99

(57) ABSTRACT

An image forming apparatus includes: a photoconductor; a light source configured to generate light forming an electrostatic latent image on the photoconductor through an optical path; a shield on the optical path configured to guard the light source from dust; a shutter configured to move with respect to the shield to interrupt the optical path; and a cleaner configured to move together with the shutter to wipe the shield along a moving track excluding an edge of the shield.

### CROSS-REFERENCE TO RELATED APPLICATION

This application is based upon and claims the benefit of priority from: U.S. provisional application 61/183641, filed on Jun. 3, 2009; U.S. provisional application 61/183655, filed on Jun. 3, 2009; U.S. provisional application 61/183656, filed on Jun. 3, 2009; and U.S. provisional application 61/187177, filed on Jun. 15, 2009, the entire contents of each of which are incorporated herein by reference.

### TECHNICAL FIELD

This specification relates to a technique for wiping a surface through which a light for exposing a photoconductor is transmitted.

### BACKGROUND

An image forming apparatus forms an electrostatic latent image on the surface of a photoconductive drum by irradiating a laser beam on the surface of the photoconductive drum. When a developer is supplied to the surface of the photoconductive drum, a developer image can be formed on the surface of the photoconductive drum.

The laser beam emitted from a light source below the photoconductive drum is transmitted through a shield and reaches the photoconductive drum. A shutter is located between the shield and the photoconductive drum. The shutter permits the laser beam to reach the photoconductive drum and prohibits the laser beam from reaching the photoconductive drum. The shutter has a brush for removing foreign matters adhering to the shield.

### DESCRIPTION OF THE DRAWINGS

FIG. 1 is a schematic diagram of the internal structure of an image forming apparatus according to a first embodiment;

FIG. 2 is a diagram of the configurations of a laser unit and a shutter unit in the first embodiment;

FIG. 3 is an external diagram of a brush and a shield in the first embodiment;

FIG. 4 is a diagram for explaining the operation of a shutter in the first embodiment;

FIG. 5 is a diagram for explaining the operation of the shutter in the first embodiment;

FIG. 6 is a diagram for explaining the operation of the shutter in the first embodiment;

FIG. 7A is a top view of a driving mechanism for the shutter in the first embodiment;

FIG. 7B is a side view of the driving mechanism for the shutter in the first embodiment;

FIG. 8 is a diagram for explaining a wiped area of the shield in the first embodiment;

FIG. 9 is a diagram of apart of a driving mechanism for a shutter in a second embodiment;

FIG. 10 is a diagram for explaining a moving path of a brush with respect to the shield in the second embodiment;

FIG. 11 is a diagram of a part of a driving mechanism for a brush in a third embodiment;

FIG. 12 is a diagram of a moving track and directions of bristle tips of the brush in the third embodiment; and

FIG. 13 is a diagram of a relation between a moving track of a follower pin and the moving track of the bristle tips of the brush in the third embodiment.

### DETAILED DESCRIPTION

According to an embodiment, an image forming apparatus comprises, a photoconductor; a light source configured to generate light forming an electrostatic latent image on the photoconductor through an optical path; a shield on the optical path configured to guard the light source from dust; a shutter configured to move with respect to the shield to interrupt the optical path; and a cleaner configured to move together with the shutter to wipe the shield along a moving track excluding an edge of the shield.

### First Embodiment

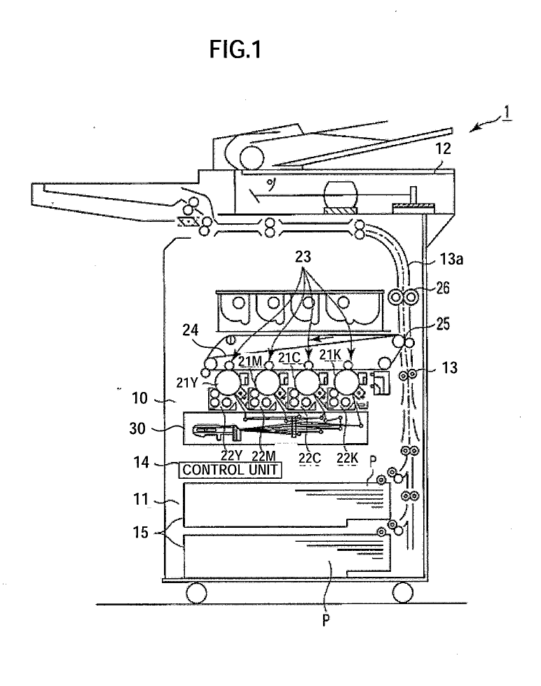

An image forming apparatus according to a first embodiment is explained with reference to FIG. 1. FIG. 1 is a schematic diagram of the internal structure of the image forming apparatus.

An image forming apparatus 1 forms a monochrome image and a color image on a sheet P using plural developers such as developers of Y (yellow), M (magenta), C (cyan), and K (black). Members corresponding to the colors (Y, M, C, and K) are denoted by reference signs with suffixes Y, M, C, and K to indicate a correspondence relation between the members and the colors.

The image forming apparatus 1 includes an image forming unit 10, a sheet feeding unit 11, an image reading unit 12, a conveying unit 13, and a control unit 14. The image forming unit 10 forms an image of characters, sentences, and graphics on the sheet P. The sheet feeding unit 11 feeds the sheet P in paper feeding cassettes 15 to the image forming unit 10. The image reading unit 12 reads an image on an original document and generates image data. The conveying unit 13 includes plural rollers and conveys the sheet P along a conveying path 13a. The control unit 14 controls the operation of the units in the image forming apparatus 1.

The image forming unit 10 includes photoconductive drums 21 (Y, M, C, and K) corresponding to the four colors. A laser unit (a light irradiation unit) 30 irradiates laser beams L corresponding to the four colors on the photoconductive drums 21 (Y, M, C, and K) to form electrostatic latent images on the surfaces of the photoconductive drums 21 (Y, M, C, and K) . The laser unit 30 is below the photoconductive drums 21 (Y, M, C, and K).

Developing units 22 (Y, M, C, and K) supply developers to the photoconductive drums 21 (Y, M, C, and K) , on which the electrostatic latent images are formed, to form developer images. Transfer rollers 23 correspond to the photoconductive drums 21 (Y, M, C, and K) and transfer the developer images formed on the photoconductive drums 21 (Y, M, C, and K) onto an intermediate transfer belt 24. A transfer unit 25 transfers the developer images, which are transferred onto the intermediate transfer belt 24, onto the sheet P that moves on a conveying path. A fixing unit 26 fixes the developer images on the sheet P.

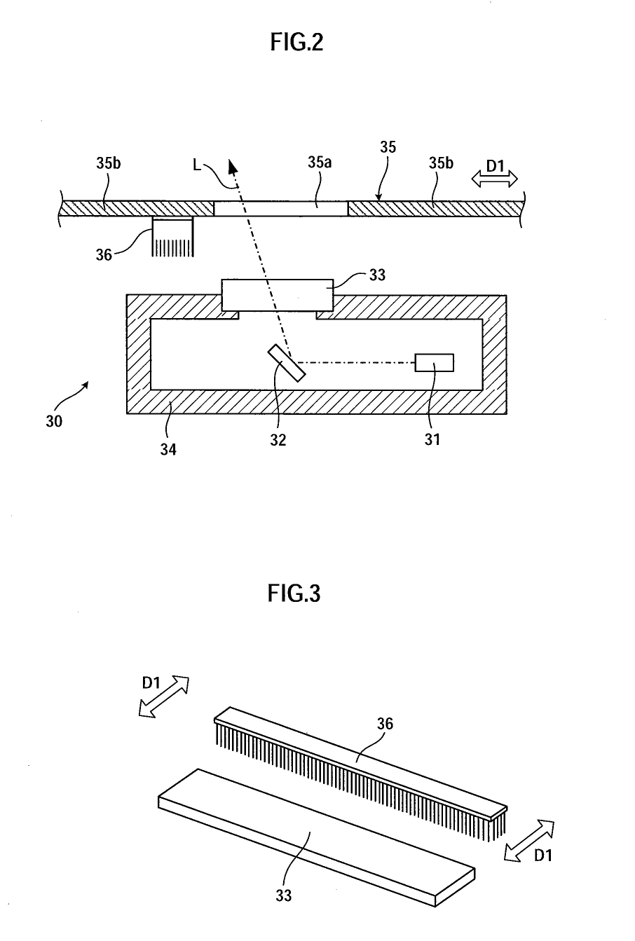

The laser unit 30 is explained below with reference to FIGS. 2 and 3.

The laser unit 30 includes a light source 31, a folding mirror 32, a shield 33, and a case 34. The case 34 houses the light source 31 and the folding mirror 32 and supports the shield 33. The light source 31 generates the laser beams L that are irradiated on the photoconductive drums 21 (Y, M, C, and K) . The structure shown in FIG. 2 corresponds to the four colors. The folding mirror 32 reflects, to the photoconductive drums 21 (Y, M, C, and K) , the laser beams L from the light source 31. The laser beams L reflected by the folding mirror 32 are transmitted through the shield 33. For example, the shield 33 is a flat glass located on the upper surface of the case 34. The shield 33 prevents the laser unit 30 from pollution. Dusts such as foreign matters spread from the photoconductive drums 21 may be a factor of the pollution. The shield 33 is in a part of an optical path of the laser beams L from the light source 31 to the photoconductive drums 21 (Y, M, C, and K) . The shield 33 extends in a scanning direction in which the laser beams L expose the photoconductive drums 21.

A shutter 35 having a flat shape is above the shield 33. The laser unit 30 and the shutter 35 are a part of an exposing device configured to expose the photoconductive drums 21 to light.

The shutter 35 has openings 35a and blocking sections 35b. The openings 35a permit the laser beams L from the shield 33 to reach the photoconductive drums 21 (Y, M, C, and K). The blocking sections 35b prevent the laser beams L from the shield 33 from reaching the photoconductive drums 21 (Y, M, C, and K). The shutter 35 has four openings 35a corresponding to the four photoconductive drums 21 (Y, M, C, and K). In FIG. 2, only one opening 35a is shown.

The shutter 35 moves in a direction indicated by an arrow D1 in FIG. 2. When the shutter 35 moves, the four openings 35a corresponding to the four colors move together. When the openings 35a are located between the photoconductive drums 21 (Y, M, C, and K) and the shield 33 according to the movement of the shutter 35, the laser beams L transmitted through the shield 33 reach the photoconductive drums 21 (Y, M, C, and K). That is, when the laser beams L reach the photoconductive drums 21 (Y, M, C, and K), the shutter 35 moves away from the laser beams L in the optical path. When the blocking sections 35b are located between the photoconductive drums 21 (Y, M, C, and K) and the shield 33, the blocking sections 35b block the laser beams L traveling from the shield 33 to the photoconductive drums 21.

The shutter 35 has a brush (a cleaner) 36 on a surface (a lower surface) opposed to the shield 33. The brush 36 is located in an area of the blocking section 35b adjacent to the opening 35a. The brush 36 is used to remove foreign matters adhering to the surface (the upper surface) of the shield 33. Since the brush 36 is fixed to the shutter 35, the brush 36 moves according to the movement of the shutter 35. As shown in FIG. 3, when the shutter 35 moves in the direction indicated by the arrow D1, the brush 36 moves in the width direction of the shield 33. The width of the shield 33 is a direction orthogonal to the longitudinal direction of the shield 33 in a plane of the shield 33 that comes into contact with the brush 36.

FIG. 2 is a diagram of the laser unit 30 viewed from the longitudinal direction of the shield 33. The opening 35a of the shutter 35 has a shape corresponding to the shield 33.

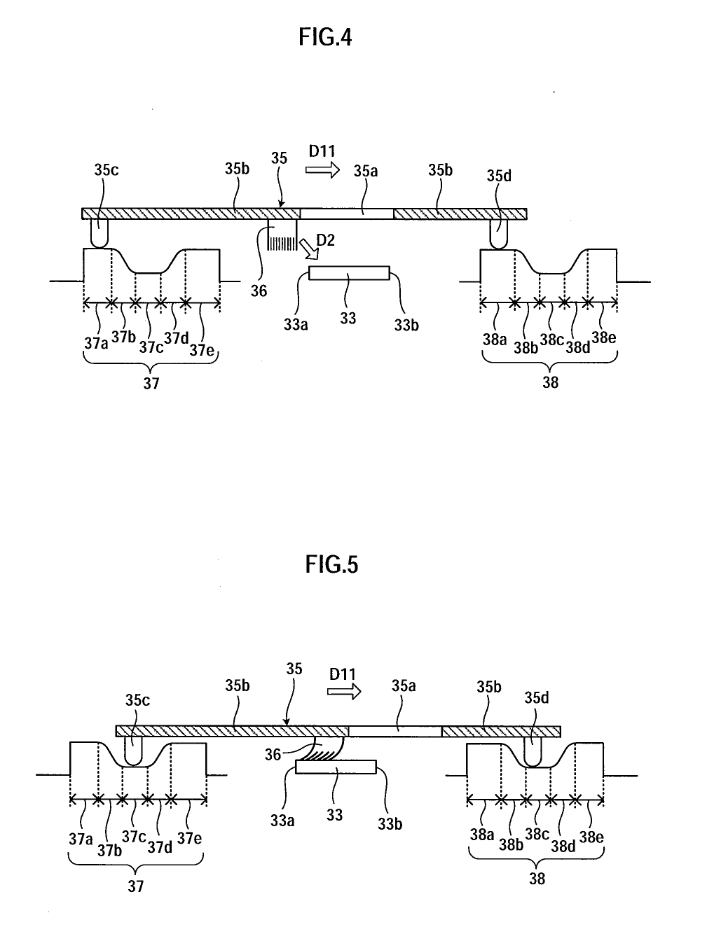

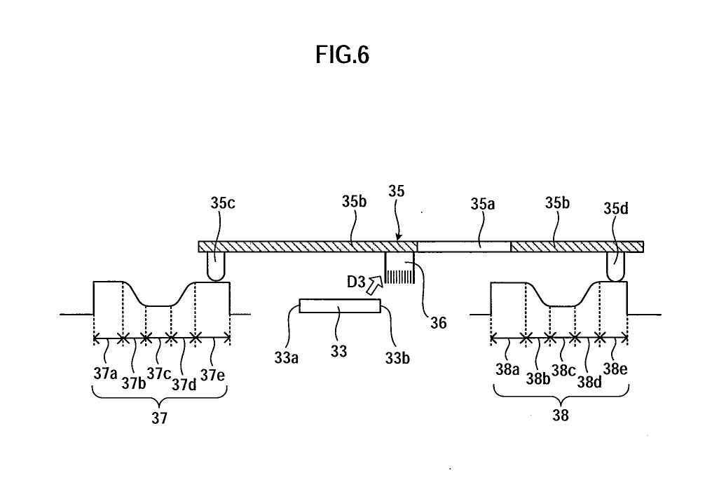

A mechanism configured to drive the shutter 35 is explained below with reference to FIGS. 4 to 6. FIG. 4 is a diagram of a state before the shield 33 is wiped. FIG. 5 is a diagram of a state while the shield 33 is wiped. FIG. 6 is a state after the shield 33 is wiped.

In the width direction of the shield 33 (a left to right direction in FIG. 4), follower pins 35c and 35d are located at both ends of the shutter 35. The follower pins 35c and 35d are fixed to a surface of the shutter 35 same as a surface on which the brush 36 is fixed (a surface on the shield 33 side). The follower pin 35c is set in contact with a guide cam 37 and moves along cam areas 37a to 37c of the guide cam 37. The follower pin 35d is set in contact with a guide cam 38 and moves along cam areas 38a to 38c of the guide cam 38. A main body of the shutter unit includes the guide cams 37 and 38 and supports the shutter 35 using the guide cams 37 and 38.

In the state shown in FIG. 4, the follower pins 35c and 35d are set in contact with the cam areas 37a and 38a of the guide cams 37 and 38. The shutter 35 is most away from the shield 33. The cam areas 37a and 38a have flat surfaces. In the state shown in FIG. 4, the brush 36 moves away from the shield 33.

When the shutter 35 moves in a direction indicated by an arrow D11 in FIG. 4, the follower pins 35c and 35d move along the cam areas 37b and 38b of the guide cams 37 and 38. The shutter 35 approaches the shield 33. When the follower pins 35c and 35d reach the cam areas 37c and 38c, the brush 36 comes into contact with the shield 33. The cam areas 37c and 38c have flat surfaces.

The cam areas 37b and 38b are inclined with respect to a plane on which the shield 33 and the shutter 35 are located. Therefore, before the brush 36 comes into contact with the shield 33, the brush 36 moves along a direction inclined with respect to the plane on which the shield 33 is located (a direction indicated by an arrow D2 in FIG. 4). The brush 36 comes into contact with a section of the shield 33 away from an edge 33a. The edge 33a is one end in the width direction of the shield 33.

When the follower pins 35c and 35d are set in contact with the cam areas 37c and 38c, a space between the shutter 35 and the shield 33 is smaller than the length of the brush 36 in a natural state. As shown in FIG. 5, the brush 36 comes into contact with the shield 33 in a flexed state. The brush 36 is flexed by, for example, the own weight of the shutter 35. The brush 36 can bend. When the brush 36 is flexed, bristle tips of the brush 36 face a direction opposite to the moving direction of the brush 36 (the direction indicated by the arrow D11).

When the follower pins 35c and 35d move along the cam areas 37c and 38c, the brush 36 moves along the upper surface of the shield 33. The brush 36 can remove foreign matters adhering to the upper surface of the shield 33 by moving along the shield 33. In this embodiment, the brush 36 enters the upper surface of the shield 33 from obliquely above. Therefore, it is possible to align directions of the bristle tips of the brush 36 in a state in which the bristle tips of the brush 36 face the direction opposite to the moving direction of the brush 36. Since the directions of the bristle tips of the brush 36 are aligned, the brush 36 can easily remove foreign matters adhering to the shield 33.

When the follower pins 35c and 35d move along cam areas 37d and 38d, the shutter 35 moves in a direction away from the shield 33. The brush 36 moves away from the shield 33. The brush 36 moves away from the shield 33 before reaching an edge 33b of the shield 33. The edge 33b is the other end in the width direction of the shield 33.

Since the cam areas 37d and 38d are inclined with respect to the plane on which the shield 33 is located, the brush 36 moves in a direction inclined with respect to the plane on which the shield 33 is located (a direction indicated by an arrow D3 in FIG. 6). The brush 36 can easily drop foreign matters on the shield 33 from the upper surface of the shield 33 by moving in the direction indicated by the arrow D3.

When the follower pins 35c and 35d reach cam areas 37e and 38e, as shown in FIG. 6, the brush 36 stops in a position away from the shield 33. The cam areas 37e and 38e have flat surfaces. In the state shown in FIG. 6, the blocking sections 35b prevent the laser beams L from the shield 33 from reaching the photoconductive drums 21 (Y, M, C, and K) .

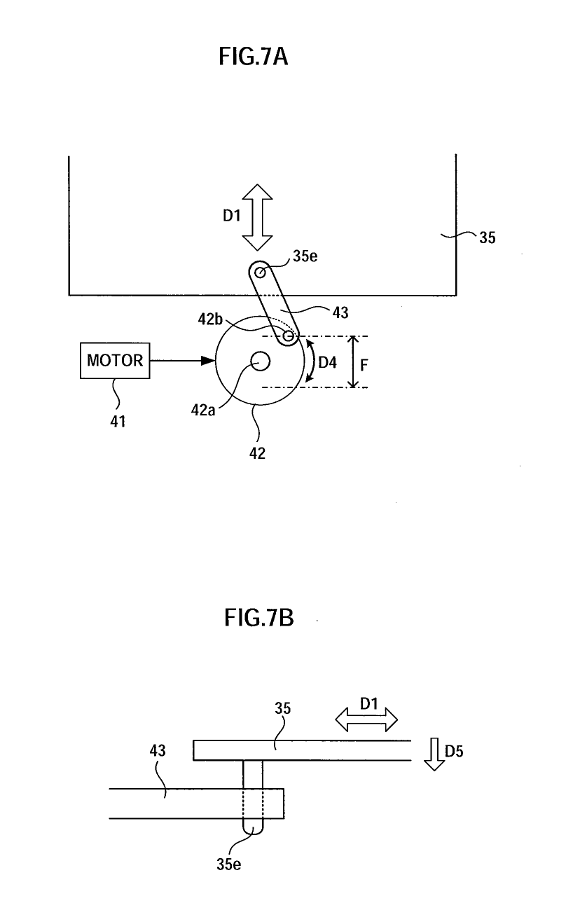

FIGS. 7A and 7B are schematic diagrams of a part of a driving mechanism configured to drive the shutter 35. FIG. 7A is a top view of the driving mechanism and FIG. 7B is a side view of a part of the driving mechanism. The driving mechanism for the shutter 35 includes the follower pins 35c and 35d and the guide cams 37 and 38.

A rotating plate 42 receives driving force from a motor 41 and rotates in a direction indicated by an arrow D4. The driving force of the motor 41 can be directly transmitted to the rotating plate 42 and can be transmitted to the rotating plate 42 via a deceleration mechanism. The rotating plate 42 rotates around a rotating shaft 42a. It is possible to switch a rotating direction of the rotating plate 42 by switching a driving direction of the motor 41. A range F shown in FIG. 7A indicates a rotation range of the rotating plate 42. The range F is equivalent to a moving range in the arrow D1 direction of the shutter 35.

The rotating plate 42 has a crank pin 42b. The crank pin 42b engages with one end of a link member 43. The other end of the link member 43 engages with a pin 35e of the shutter 35. The pin 35e is located on a surface (a lower surface) of the shutter 35 same as a surface on which the brush 36 is located. The pin 35e can also be provided on the upper surface rather than the lower surface of the shutter 35.

The link member 43 converts rotational motion of the rotting plate 42 into linear motion of the shutter 35. The shutter 35 moves in the direction indicated by the arrow Dl. The main body of the shutter unit guides the shutter 35 in the direction indicated by the arrow D1.

A state shown in FIG. 7B is a state in which the shutter 35 is most away from the shield 33. The state corresponds to the state shown in FIGS. 4 and 6. In this embodiment, the shutter 35 moves in a direction indicated by an arrow D5 in FIG. 7B, i.e., a direction approaching the shield 33. As the shutter 35 approaches the shield 33, the pin 35e moves downward with respect to the link member 43. When the shutter 35 is closest to the shield 33 (the state shown in FIG. 5) , there is a space between the link member 43 and the shutter 35. If the shutter 35 comes into contact with the link member 43 before the follower pins 35c and 35d come into contact with the cam areas 37c and 38c, the shutter 35 cannot move along the guide cams 37 and 38.

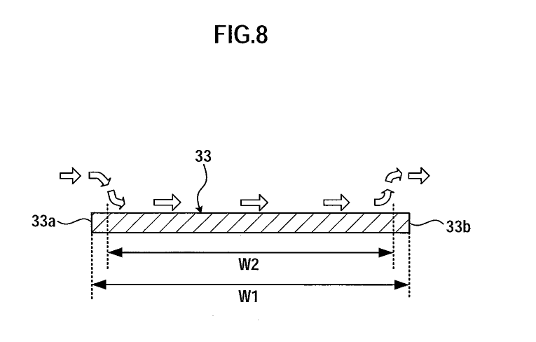

The follower pins 35c and 35d move from the cam areas 37a and 38a to the cam area 37e and 38e of the guide cams 37 and 38, whereby the brush 36 moves along a track indicated by arrows in FIG. 8. In FIG. 8, W1 indicates the width (the total length) of the shield 33 and W2 indicates a contact area of the brush 36 and the shield 33 in the width direction of the shield 33. The laser beam L is transmitted through the shield 33 in the contact area W2 of the brush 36 and the shield 33.

As shown in FIG. 8, the brush 36 is away from the edges 33a and 33b of the shield 33. Specifically, the brush 36 approaches the shield 33 after passing the edge 33a and moves away from the shield 33 before reaching the edge 33b.

When the shutter 35 slides only in a surface parallel to the upper surface of the shield 33, the brush 36 comes into contact with the edge 33a and the edge 33b of the shield 33. When the brush 36 strikes against the edge 33a and the edge 33b of the shield 33, it is likely that the edge 33a and the edge 33b are shaved and chips are formed. A fragment may be produced from the edge 33a and the edge 33b grazed by the brush 36.

In this embodiment, since the brush 36 moves away from the edges 33a and 33b of the shield 33, it is possible to prevent the brush 36 from shaving the edges 33a and 33b.

When the brush 36 moves away from the shield 33, the brush 36 returns from the flexed state to the natural state. When the brush 36 returns to the natural state, the brush 36 can remove foreign matters on the shield 33 from the shield 33. Therefore, it is possible to prevent foreign matters from accumulating on the upper surface of the shield 33.

In the explanation with reference to FIGS. 4 to 6, the follower pins 35c and 35d move from the cam areas 37a and 38a to the cam areas 37e and 38e. Operation opposite to that shown in FIGS. 4 to 6 is performed when the follower pins 35c and 35d move from the cam areas 37e and 38e to the cam areas 37a and 38a.

In this embodiment, the brush 36 is prevented from coming into contact with two edges 33a and 33b of the shield 33. However, it is also possible to prevent the brush 36 from coming into contact with only one of the edges 33a and 33b. Specifically, in the guide cam 37 (38) , it is possible to use only one of the cam areas 37b and 37d (38b and 38d) and form the other cam area as a flat surface.

In this embodiment, the shutter 35 has the follower pins 35c and 35d and the case 34 of the laser unit 30 has the guide cams 37 and 38. However, the configuration may be opposite. Specifically, the case 34 may have pins equivalent to the follower pins 35c and 35d and the shutter 35 may have cams equivalent to the guide cams 37 and 38.

A mechanism configured to drive the shutter 35 is not limited to the mechanism explained in this embodiment (a slider crank mechanism). As the mechanism, it is possible to use both a driving mechanism configured to drive the shutter 35 (including the brush 36) in a direction away from the shield 33 and a direction approaching the shield 33 and a driving mechanism configured to drive the brush 36 in a direction along the upper surface of the shield 33.

A member wiping the shield 33 is not limited to the brush 36. The member only has to be able to come into contact with the shield 33 and remove foreign matters adhering to the shield 33. For example, foam such as sponge and an elastic blade can be used instead of the brush 36. Since the brush 36 has plural bristles, the brush 36 can be easily moved along the upper surface of the shield 33. For example, when a parallel state between the shield 33 and the shutter 35 shifts, and the shield 33 and the shutter 35 bend, the brush 36 is suitably used.

In this embodiment, the shield 33 is used. However, a material other than glass can be used. The material only has to be a material through which the laser beam L from the light source 31 can be transmitted. For example, resin can be used.

Processing for improving lubricity can be applied to the upper surface of the shield 33. For example, water-repellent coating, slipping-property improvement coating, application of a lubricant, and application of a surface active agent can be performed. If the lubricity on the upper surface of the shield 33 is improved, it is possible to suppress foreign matters from adhering to the upper surface of the shield 33.

### Second Embodiment

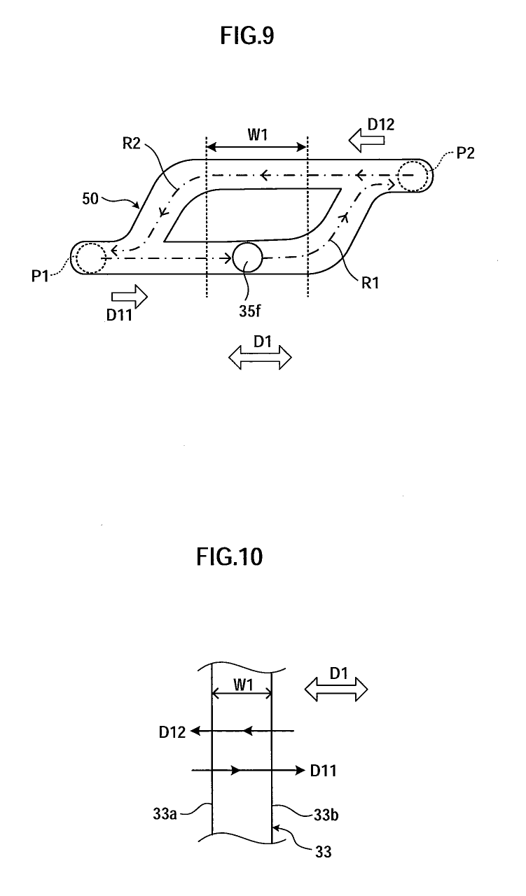

An image forming apparatus according to a second embodiment is explained below. Members having functions same as those of the members explained in the first embodiment are denoted by the same reference numerals and signs. Explanation of the members is omitted. Differences from the first embodiment are explained below with reference to FIGS. 9 and 10. FIG. 9 is a diagram of a part of the driving mechanism for the shutter 35. FIG. 10 is a diagram for explaining a moving path of the brush 36 with respect to the shield 33. The arrow D1 shown in FIGS. 9 and 10 indicates a moving direction of the shutter 35 (including the brush 36).

The shutter 35 has a follower pin 35f . The follower pin 35f is equivalent to the follower pins 35c and 35d explained in the first embodiment. The case 34 of the laser unit 30 has a guide groove 50 in which the follower pin 35f engages. The guide groove 50 corresponds to the guide cams 37 and 38 explained in the first embodiment.

As in the first embodiment, the shutter 35 receives the torque of the rotating plate 42 and moves in the direction indicated by the arrow D1. When the shutter 35 moves in the direction indicated by the arrow D1, the follower pin 35f moves along the guide groove 50. In this embodiment, the shutter 35 moves only in the direction substantially parallel to the upper surface of the shield 33. In other words, the shutter 35 is prevented from moving in the direction approaching the shield 33 and the direction away from the shield 33.

The guide groove 50 has a path (a forward path) R1 and a path (a backward path) R2. Both ends of the two paths R1 and R2 are connected to each other. When the shutter 35 moves in the direction indicated by the arrow D11, the follower pin 35f moves along the path R1 and reaches from a position P1 to a position P2. When the shutter 35 moves in the direction indicated by the arrow D11, the brush 36 moves along the upper surface of the shield 33.

An area W1 shown in FIG. 9 is equivalent to the width (the total length) of the shield 33. The paths R1 and R2 in the area W1 are substantially parallel to each other. The area W1 extends in the width direction of the shield 33. When the follower pin 35f moves on the path R1 in the area W1, as indicated by the arrow D11 in FIG. 10, the brush 36 moves along the width direction of the shield 33.

After the follower pin 35f reaches from the position P1 to the position P2, the follower pin 35f returns from the position P2 to the position P1. When the shutter 35 moves in a direction indicated by an arrow D12, the follower pin 35f moves along the path R2 and reaches from the position P2 to the position P1. When the shutter 35 moves in the direction indicated by the arrow D12, the brush 36 moves along the upper surface of the shield 33.

When the follower pin 35f moves on the path R2 in the area W1, as indicated by the arrow D12 in FIG. 10, the brush 36 moves along the width direction of the shield 33.

The path R1 and the path R2 in the area W1 are separated in an up to down direction in FIG. 9. The up to down direction in FIG. 9 is equivalent to the longitudinal direction of the shield 33 (an up to down direction in FIG. 10). A position of the brush 36 coming into contact with the shield 33 shifts in the longitudinal direction of the shield 33 between the time when the brush 36 moves in the direction indicated by the arrow D11 and the time when the brush 36 moves in the direction indicated by the arrow D12. Tracks indicated by the arrows D11 and D12 in FIG. 10 indicate moving tracks at the same point of the brush 36.

When the brush 36 reciprocatingly moves with respect to the shield 33, it is possible to suppress, by changing a contact position of the brush 36 with the shield 33, the shield 33 from being shaved by the brush 36.

When the brush 36 reciprocatingly moves on the same path with respect to the shield 33, the brush 36 comes into contact with the same area of the shield 33. When the brush 36 comes into contact with the same area of the shield 33, it is likely that the shield 33 tends to be shaved and chips of the shield 33 tend to grow on the shield 33.

On the other hand, when the contact position of the brush 36 with the shield 33 is changed, a contact state of the brush 36 with the shield 33 can be changed on the forward path and the backward path of the brush 36. When the contact state of the brush 36 is changed, since the load of the brush 36 on the shield 33 is dispersed, the shield 33 can be suppressed from being shaved.

A distance of shift of the paths R1 and R2 in the area W1 in the longitudinal direction of the shield 33 can be set as appropriate. An area of the shield 33 through which the laser beam L is transmitted needs to be wiped by the brush 36.

In this embodiment, the brush 36 moves only in the surface parallel to the upper surface of the shield 33. However, as in the first embodiment, it is possible to move the brush 36 close to the shield 33 and move the brush 36 away from the shield 33. Specifically, the structure explained in this embodiment and the structure explained in the first embodiment only have to be combined.

In this embodiment, the follower pin 35f moves along the guide groove 50, whereby the brush 36 moves in the longitudinal direction and the width direction of the shield 33. Any mechanism may be adopted as long as the brush 36 can move in the longitudinal direction and the width direction of the shield 33.

For example, it is possible to drive the shutter 35 along a moving track same as that in this embodiment using a first driving mechanism configured to drive the shutter 35 (including the brush 36) in the longitudinal direction of the shield 33 and a second driving mechanism configured to drive the shutter 35 in the width direction of the shield 33. It is possible to drive the shutter 35 in various moving tracks by changing a driving amount of the shutter 35 by the first driving mechanism and a driving amount of the shutter 35 by the second driving mechanism.

This embodiment is a specific form of an embodiment described below.

(1-1). An image forming apparatus includes:

a photoconductor;

a light source configured to generate light forming an electrostatic latent image on the photoconductor through an optical path;

a shield on the optical path configured to guard the light source from dust;

a shutter configured to move with respect to the shield to interrupt the optical path; and

a cleaner configured to move together with the shutter to wipe the shield along a moving track different from each other.

(1-2). The apparatus according to (1-1) , wherein

the shield extends in a scanning direction of the light with respect to the photoconductor, and

the moving tracks of the cleaner reciprocatingly moving on the shield shift in the longitudinal direction of the shield.

(1-3). The apparatus according to (1-1), further comprising:

a case configured to house the light source and support the shield; and

a driving mechanism configured to drive the shutter and the cleaner,

wherein

the driving mechanism includes:
a cam; and
a cam follower configured to engage with the cam.
   (1-4). The apparatus according to (1-1), wherein

the light source is below the photoconductor, and

the shield is above the light source.

(1-5). The apparatus according to (1-1), wherein the cleaner is a brush.

### Third Embodiment

An image forming apparatus according to a third embodiment is explained below. Members having functions same as those of the members explained in the first and second embodiments are denoted by the same reference numerals and signs. Detailed explanation of the members is omitted. Differences from the first and second embodiments are mainly explained below.

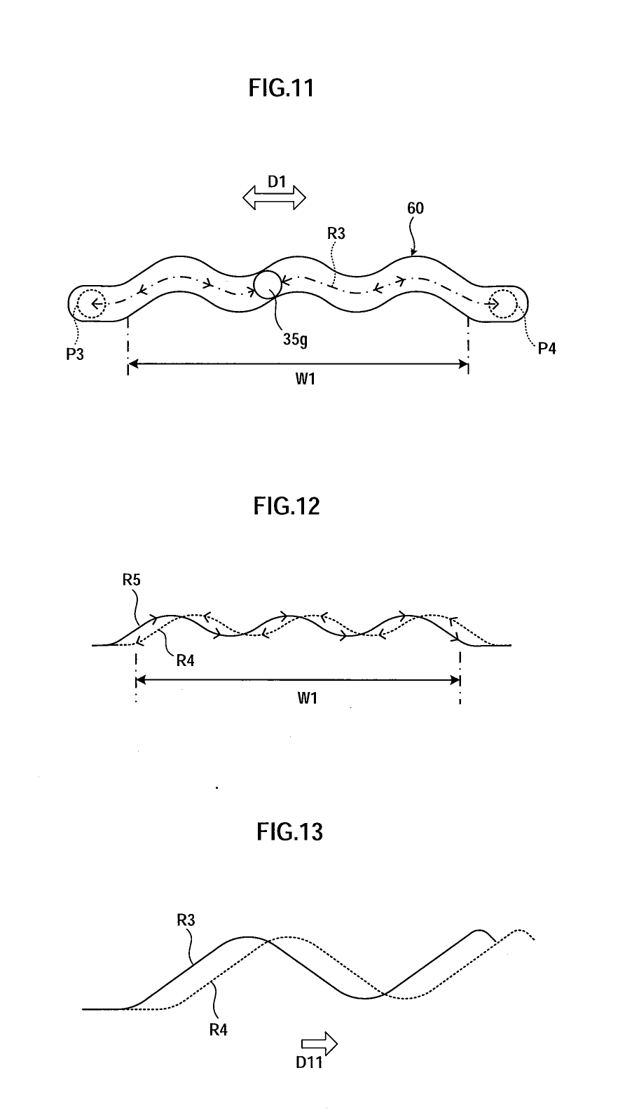

In this embodiment, as in the second embodiment, the brush 36 moves not only in the width direction of the shield 33 but also in the longitudinal direction of the shield 33. The shutter 35 has a follower pin 35g shown in FIG. 11. The follower pin 35g is equivalent to the follower pins 35c and 35d explained in the first embodiment. The case 34 of the laser unit 30 has a guide groove 60 in which the follower pin 35g is engaged. The guide groove 60 corresponds to the guide cams 37 and 38 explained in the first embodiment.

As in the first embodiment, the shutter 35 receives the torque of the rotating plate 42 and moves in the direction indicated by the arrow Dl. When the shutter 35 moves in the direction indicated by the arrow D1, the follower pin 35g moves along the guide groove 60. In this embodiment, the shutter 35 moves only in the direction substantially parallel to the upper surface of the shield 33. In other words, the shutter 35 is prevented from moving in the direction approaching the shield 33 and the direction away from the shield 33.

When the shutter 35 moves in the direction indicated by the arrow D1, the follower pin 35g moves along the guide groove 60. A moving track R3 of the follower pin 35g has a wavy form.

In this embodiment, the follower pin 35g reciprocatingly moves on the same path. However, by forming the moving track R3 of the follower pin 35g in a wavy form, it is possible to change, on the forward path and the backward path of the brush 36, a position where the bristle tips of the brush 36 come into contact with the shield 33.

R4 indicated by a dotted line in FIG. 12 indicates a moving track at the bristle tips of the brush 36 at the time when the follower pin 35g moves from a position P3 to a position P4 (see FIG. 11) . Arrows on the moving track R4 indicate the direction of the bristle tips of the brush 36. After moving to the position P4, the follower pin 35g returns to the position P3.

R5 indicated by a solid line in FIG. 12 indicates a moving track at the bristle tips of the brush 36 at the time when the follower pin 35g moves from the position P4 to the position P3. Arrows on the moving track R5 indicate the direction of the bristle tips of the brush 36.

As in the first embodiment, the brush 36 comes into contact with the shield 33 in the flexed state. Therefore, the bristle tips of the brush 36 coming into contact with the shield 33 are delayed with respect to the movement of the follower pin 35g. The moving tracks R4 and R5 at the bristle tips of the brush 36 substantially coincide with the moving track R3 of the follower pin 35g. However, phases of the moving tracks R4 and R5 at the bristle tips of the brush 36 shift with respect to the moving track R3 of the follower pin 35g.

FIG. 13 is a diagram of a relation between the moving track R3 of the follower pin 35g and the moving track R4 at the bristle tips of the brush 36 at the time when the brush 36 moves in the direction indicated by the arrow D11. When the brush 36 moves in the opposite direction of the direction indicated by the arrow D11, a relation between the moving track R3 of the follower pin 35g and the moving track R5 at the bristle tips of the brush 36 is the same as the relation shown in FIG. 13.

In this embodiment, when the brush 36 moves on the forward path and the backward path, as shown in FIG. 12, the moving tracks R4 and R5 at the bristle tips of the brush 36 are different. In other words, when the brush 36 reciprocatingly moves with respect to the shield 33, contact positions of the brush 36 with the shield 33 are different.

When the moving tracks R4 and R5 are different, it is possible to change a contact state of the brush 36 with the shield 33. When the contact state of the brush 36 changes, the load of the brush 36 on the shield 33 is dispersed. Therefore, it is possible to suppress the shield 33 from being shaved. In this embodiment, it is possible to obtain an effect same as that in the second embodiment.

In this embodiment, the brush 36 comes into contact with the edge of the shield 33. However, as explained in the first embodiment, the brush 36 can be configured to move away from the edge of the shield 33. Specifically, the structure explained in this embodiment and the structure explained in the first embodiment can be combined.

In this embodiment, the follower pin 35g moves along the guide groove 60, whereby the brush 36 moves in the width direction of the shield 33 while swinging in the longitudinal direction of the shield 33. Any mechanism may be adopted as long as the brush 36 can move in the width direction of the shield 33 while swinging in the longitudinal direction of the shield 33.

For example, it is possible to drive the shutter 35 along the moving track R3 same as that in this embodiment using the first driving mechanism configured to drive the shutter 35 (including the brush 36) in the longitudinal direction of the shield 33 and the second driving mechanism configured to drive the shutter 35 in the width direction of the shield 33. It is possible to drive the shutter 35 in various moving tracks by changing a driving amount of the shutter 35 by the first driving mechanism and a driving amount of the shutter 35 by the second driving mechanism.

This embodiment is a specific form of an embodiment described below.

(2-1). An image forming apparatus includes:

a photoconductor;

a light source configured to generate light forming an electrostatic latent image on the photoconductor through an optical path;

a shield on the optical path configured to guard the light source from dust;

a shutter configured to move with respect to the shield to interrupt the optical path; and

a cleaner configured to move together with the shutter to wipe the shield along a moving track having a wavy form.

(2-2). The apparatus according to (2-1), wherein the shield extends in a scanning direction of the light with respect to the photoconductor, and

the cleaner reciprocatingly moves in a direction orthogonal to the longitudinal direction of the shield.

(2-3). The apparatus according to (2-2), wherein the cleaner moves in the direction orthogonal to the longitudinal direction of the shield while swinging in the longitudinal direction of the shield.
(2-4). The apparatus according to (2-1), further comprising:

a case configured to house the light source and support the shield; and

a driving mechanism configured to drive the shutter and the cleaner,

wherein

the driving mechanism includes:
a cam; and
a cam follower configured to engage with the cam.
   (2-5). The apparatus according to (2-1), wherein the light source is below the photoconductor, and the shield is above the light source.
   (2-6). The apparatus according to (2-1), wherein the cleaner is a brush.

### Fourth Embodiment

A device having a cleaner according to a fourth embodiment is explained below. Members having functions same as those of the members explained in the first embodiment are denoted by the same reference numerals and signs. Detailed explanation of the members is omitted. Differences from the first embodiment are mainly explained below.

In this embodiment, a material excluding carbon black is used as a material of the brush 36. Since the carbon black is excluded from the brush 36, it is possible to prevent carbon black from adhering to the upper surface of the shield 33. It is possible to prevent the laser beam L transmitted through the shield 33 from being attenuated by carbon black adhering to the shield 33.

As the brush 36, it is desirable to use the brush 36 that is not dyed. When the undyed brush 36 is used, it is possible to prevent a dyeing agent from adhering to the upper surface of the shield 33. It is possible to prevent the laser beam L transmitted through the shield 33 from being attenuated by a dyeing agent adhering to the shield 33.

As a material of the brush 36, 6-nylon can be used. It is possible to suppress wear of the brush 36 and improve the life of the brush 36 by using the 6-nylon.

The brush 36 explained in this embodiment can be applied to the brush 36 used in the first to third embodiments.

The present invention can be carried out in other various forms without departing from the spirit or the main characteristics of the present invention. Therefore, the embodiment is only an exemplar in every aspect and should not be limitedly interpreted. The scope of the present invention is indicated by the scope of claims and is by no means restricted by the text of the specification. Further, all modifications and various improvements, substitutions, and alterations belonging to the scope of equivalents of the scope of claims are within the scope of the present invention.

What is claimed is:

1. An image forming apparatus comprising:
a photoconductor;
a light source configured to generate light forming an electrostatic latent image on the photoconductor through an optical path;
a shield on the optical path configured to guard the light source from dust;
a shutter configured to move with respect to the shield to interrupt the optical path; and
a cleaner configured to move together with the shutter to wipe the shield along a moving track excluding an edge of the shield.

2. The apparatus according to clam 1, wherein
the light source is below the photoconductor, and
the shield is above the light source.

3. The apparatus according to claim 1, further comprising:
a case configured to house the light source and support the shield; and
a driving mechanism configured to drive the shutter and the cleaner,
wherein
the driving mechanism includes:
a cam; and
a cam follower configured to engage with the cam.

4. The apparatus according to claim 3, wherein the driving mechanism drives the cleaner from a position away from the shield to a position further on an inner side than the edge of the shield.

5. The apparatus according to claim 4, wherein the driving mechanism drives, when the cleaner comes into contact with the shield, the cleaner in a direction inclined with respect to a surface of the shield.

6. The apparatus according to claim 3, wherein the driving mechanism moves the cleaner away from the shield before the cleaner coming into contact with the shield reaches the edge of the shield.

7. The apparatus according to claim 6, wherein the driving mechanism drives, in moving the cleaner away from the shield, the cleaner in a direction inclined with respect to a surface of the shield.

8. The apparatus according to claim 1, wherein the cleaner comes into contact with an area of the shield crossing the optical path.

9. The apparatus according to claim 1, wherein
the shield extends in a scanning direction of the light with respect to the photoconductor, and
the cleaner moves in a direction orthogonal to a longitudinal direction of the shield.

10. The apparatus according to claim 1, wherein the cleaner is a brush.

11. The apparatus according to claim 10, wherein the brush is flexed according to contact with the shield.

12. The apparatus according to claim 11, wherein, when the brush is flexed, bristle tips of the brush face a direction opposite to a moving direction of the brush.

13. An exposing device configured to expose a photoconductor to light, the exposing device comprising:
a light source configured to generate light forming an electrostatic latent image on the photoconductor through an optical path;
a shield on the optical path configured to guard the light source from dust;
a shutter configured to move with respect to the shield to interrupt the optical path; and
a cleaner configured to move together with the shutter to wipe the shield along a moving track excluding an edge of the shield.

14. The device according to claim 13, wherein
the light source is below the photoconductor, and
the shield is above the light source.

15. The device according to claim 13, further comprising:
a case configured to house the light source and support the shield; and
a driving mechanism configured to drive the shutter and the cleaner,
wherein
the driving mechanism includes:
a cam; and
a cam configured to engage with the cam.

16. The device according to claim 15, wherein the driving mechanism drives the cleaner from a position away from the shield to a position further on an inner side than the edge of the shield.

17. The device according to claim 13, wherein the driving mechanism moves the cleaner away from the shield before the cleaner coming into contact with the shield reaches the edge of the shield.

18. The device according to claim 13, wherein the cleaner is a brush.

19. The device according to claim 18, wherein the brush is flexed according to contact with the shield and bristle tips of the brush face a direction opposite to a moving direction of the brush.

20. An image forming method comprising:
reaching light from a light source to a photoconductor after being transmitted through a shield and forming an electrostatic latent image on a surface of the photoconductor ;
supplying a developer to the photoconductor to form a developer image corresponding to the electrostatic latent image; and
when a shutter moves with respect to the shield to interrupt an optical path, moving a cleaner together with the shutter to wipe the shield along a moving track excluding an edge of the shield.
